(19) United States
(12) Patent Application Publication
(10) Pub. No.: US 2022/0163330 A1
(43) Pub. Date: May 26, 2022

(54) INFORMATION PROCESSING APPARATUS, PROGRAM, AND INFORMATION PROCESSING METHOD

(71) Applicant: SONY GROUP CORPORATION, Tokyo (JP)

(72) Inventor: Hiroyuki KAMATA, Kanagawa (JP)

(73) Assignee: SONY GROUP CORPORATION, Tokyo (JP)

(21) Appl. No.: 17/441,462

(22) PCT Filed: Mar. 12, 2020
(86) PCT No.: PCT/JP2020/010805

§ 371 Date: Sep. 21, 2021

(30) Foreign Application Priority Data
Mar. 28, 2019 (JP) 2019-062943

(51) Int. Cl. G01C 21/08

(52) U.S. Cl. CPC G01C 21/08

(57) ABSTRACT

There is provided an information processing apparatus, a program, and an information processing method that are capable of achieving autonomous positioning by geomagnetism without requiring a geomagnetic map, the information processing apparatus including: an acquisition unit; and a calculation unit. The acquisition unit acquires a spatial magnetic gradient and a temporal magnetic change. The calculation unit estimates a motion vector on the basis of the magnetic gradient and the magnetic change.

### TECHNICAL FIELD

The present technology relates to an information processing apparatus, a program, and an information processing method according to autonomous positioning.

### BACKGROUND ART

An autonomous positioning technology is used to control the movement of a drone, a transfer robots, and the like. In autonomous positioning, IMU (inertial measurement unit), SLAM (Simultaneous Localization and Mapping), LiDAR (Light Detection and Ranging, Laser Imaging Detection and Ranging), and the like are generally used. However, in the calculation from the acceleration using IMU, errors are accumulated and the accuracy becomes often insufficient. Further, in a method based on optical observation such as SLAM and LiDAR, there are problems that power consumption is large and the environmental dependency of the accuracy is large.

Meanwhile, in recent years, a method of using geomagnetism for autonomous positioning has been studied. For example, Patent Literature 1 discloses a technology for performing autonomous positioning using a geomagnetic map. Since geomagnetism is not uniform indoors and is affected by the arrangement of reinforcing bars contained in building materials of a building, or the like, a geomagnetic map obtained by mapping geomagnetism distribution can be utilized for autonomous positioning.

### CITATION LIST

### Patent Literature

Patent Literature 1: Japanese Patent Application Laid-open No. 2018-063679

### DISCLOSURE OF INVENTION

### Technical Problem

However, in the technology described in Patent Literature 1, there is a need to perform measurement in which the position and geomagnetism are associated with each other in advance, and to create a geomagnetic map database. Further, there is also a need for a way to distribute the geomagnetic map database. Further, the geomagnetic map is affected by the change of the magnetization condition of the reinforcing bars, or the like, and changes over time. For this reason, there is a need to periodically perform measurement and update the geomagnetic map.

In view of the circumstances as described above, it is an object of the present technology to provide an information processing apparatus, a program, and an information processing method that are capable of achieving autonomous positioning by geomagnetism without requiring a geomagnetic map.

### Solution to Problem

In order to achieve the above-mentioned object, an information processing apparatus according to the present technology includes: an acquisition unit; and a calculation unit.

The acquisition unit acquires a spatial magnetic gradient and a temporal magnetic change.

The calculation unit estimates a motion vector on the basis of the magnetic gradient and the magnetic change.

In accordance with this configuration, the information processing apparatus is capable of estimating the motion vector using the spatial magnetic gradient and the temporal magnetic change, and does not need to use a geomagnetic map. Therefore, it is possible to execute autonomous positioning even in a place where no geomagnetic map is crated.

The acquisition unit may acquire the magnetic gradient and the magnetic change from a magnetic detection unit mounted on a moving object, and

the calculation unit may estimate a motion vector of the moving object.

The magnetic detection unit may include a plurality of magnetic sensors that detects geomagnetism, and

the acquisition unit may acquire the magnetic gradient from a difference between magnetic strengths output from the plurality of magnetic sensors.

The magnetic detection unit may include a magnetic gradient sensor that detects the magnetic gradient and a magnetic sensor that detects the magnetic change.

The acquisition unit and the calculation unit may be mounted on the moving object.

The acquisition unit may receive the magnetic gradient and the magnetic change from the moving object.

The calculation unit may further estimate, on a basis of the motion vector, an amount of movement of the moving object.

The magnetic detection unit may include at least two magnetic sensors, and

the calculation unit may estimate a one-dimensional motion vector.

The magnetic detection unit may include at least three magnetic sensors, and

the calculation unit may estimate a two-dimensional motion vector.

The magnetic detection unit may include at least four magnetic sensors, and

the calculation unit may estimate a three-dimensional motion vector.

The acquisition unit may further acquire an output of an inertial measurement device, and

the calculation unit may correct, by the motion vector, a velocity calculated on the basis of the output of the inertial measurement device.

The acquisition unit may further acquire an output of an optical positioning device, and

the calculation unit may estimate, where another moving object is detected by the optical positioning device, an amount of movement of the moving object on which the magnetic detection unit is mounted, on the basis of the motion vector calculated on the basis of the magnetic gradient and the magnetic change.

The acquisition unit may further acquire an output of an optical positioning device, and

the calculation unit may compare a first amount of movement and a second amount of movement with each other, the first amount of movement being estimated on the basis of an output of the optical positioning device, the second amount of movement being estimated on the basis of the motion vector calculated on the basis of the magnetic gradient and the magnetic change, and estimate, where a difference between the first amount of movement and the second amount of movement is larger than a threshold value, the second amount of movement as an amount of movement of the moving object.

The acquisition unit may further acquire an output of an optical positioning device, and

the calculation unit may integrate a first amount of movement and a second amount of movement by a sensor fusion technology, the first amount of movement being estimated on the basis of an output of the optical positioning device, the second amount of movement being estimated on the basis of the motion vector calculated on the basis of the magnetic gradient and the magnetic change, and estimate an amount of movement of the moving object.

In order to achieve the above-mentioned object, a computer-readable storage medium according to the present technology is a computer-readable storage medium stored with a program which, when executed by a processor of an information processing apparatus, causes the information processing apparatus to function as: an acquisition unit; and a calculation unit.

The acquisition unit acquires a spatial magnetic gradient and a temporal magnetic change.

The calculation unit estimates a motion vector on the basis of the magnetic gradient and the magnetic change.

In order to achieve the above-mentioned object, an information processing method according to the present technology includes: acquiring, by an acquisition unit, a spatial magnetic gradient and a temporal magnetic change.

A calculation unit estimates a motion vector on the basis of the magnetic gradient and the magnetic change.

### BRIEF DESCRIPTION OF DRAWINGS

FIG. 1 is a block diagram showing a configuration of an information processing apparatus according to an embodiment of the present technology.

FIG. 2 shows an example of a geomagnetic map.

FIG. 3 is a schematic diagram showing the operation principles of the information processing apparatus according to the embodiment of the present technology.

FIG. 4 is a schematic diagram showing a configuration and an operation of the information processing apparatus that estimates a one-dimensional motion vector.

FIG. 5 is a graph showing a spatial magnetic gradient acquired by an acquisition unit included in the information processing apparatus.

FIG. 6 is a graph showing a temporal magnetic change acquired by the acquisition unit included in the information processing apparatus.

FIG. 7 is a schematic diagram showing a configuration of the information processing apparatus that estimates a two-dimensional motion vector.

FIG. 8 is a schematic diagram showing an operation of the information processing apparatus that estimates a two-dimensional motion vector.

FIG. 9 is a schematic diagram showing a configuration of the information processing apparatus that estimates a three-dimensional motion vector.

FIG. 10 is a schematic diagram showing an operation of the information processing apparatus that estimates a three-dimensional motion vector.

FIG. 11 is a block diagram showing another configuration of a magnetic detection unit included in the information processing apparatus.

FIG. 12 is a block diagram showing another configuration of the information processing apparatus.

FIG. 13 is a block diagram showing a configuration of the information processing apparatus that includes an inertial measurement device according to this embodiment.

FIG. 14 is a schematic diagram showing a positioning calculation method of the information processing apparatus.

FIG. 15 is a block diagram showing a configuration of the information processing apparatus that includes an optical positioning device according to this embodiment.

FIG. 16 is a flowchart showing a control example 1 of the information processing apparatus.

FIG. 17 is a flowchart showing a control example 2 of the information processing apparatus.

FIG. 18 is a flowchart showing a control example 3 of the information processing apparatus.

FIG. 19 is a flowchart showing an application example 1 of the information processing apparatus.

FIG. 20 is a flowchart showing the application example 1 of the information processing apparatus.

FIG. 21 is a flowchart showing an application example 2 of the information processing apparatus.

FIG. 22 is a block diagram showing a hardware configuration of the information processing apparatus according to this embodiment.

### MODE(S) FOR CARRYING OUT THE INVENTION

An information processing apparatus according to an embodiment of the present technology will be described.

[Configuration of Information Processing Apparatus]

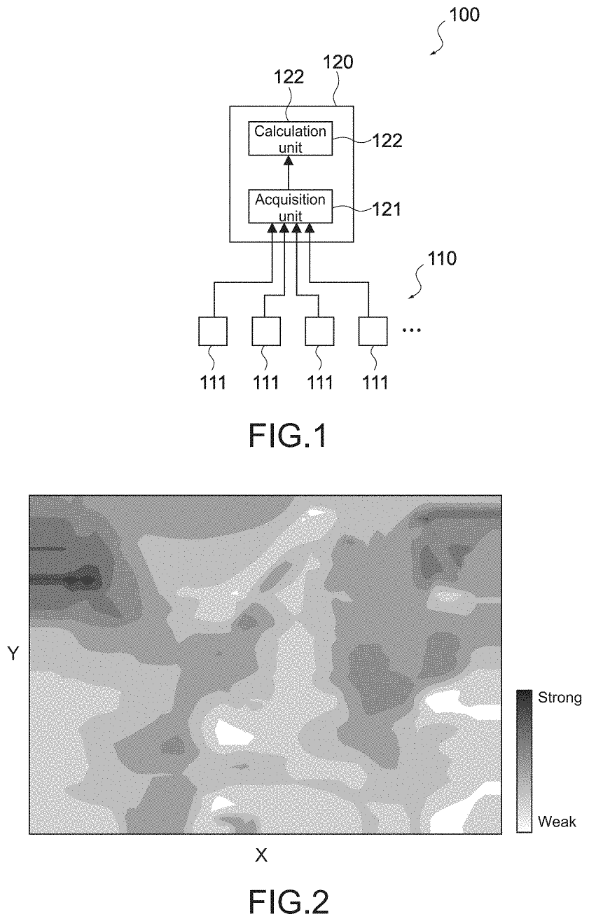

FIG. 1 is a block diagram showing a configuration of an information processing apparatus 100 according to this embodiment. The information processing apparatus 100 may be mounted on a moving object such as a robot and a drone. As shown in FIG. 1, the information processing apparatus 100 includes a magnetic detection unit 110 and an information processing unit 120. Note that each configuration of the information processing apparatus 100 is a functional configuration realized by the cooperation of hardware and software.

The magnetic detection unit 110 includes a plurality of magnetic sensors 111, and detects a spatial magnetic gradient and a temporal magnetic change of a periphery of the information processing apparatus 100. Each of the plurality of magnetic sensors 111 detects geomagnetism. Each magnetic sensor 111 only needs to be capable of detecting geomagnetism, and the configuration thereof is not particularly limited. The number of the magnetic sensors 111 included in the magnetic detection unit 110 is not limited to four.

The information processing unit 120 includes an acquisition unit 121 and a calculation unit 122. As will be described below, the acquisition unit 121 acquires a spatial magnetic gradient and a temporal magnetic change from the magnetic detection unit 110, and supplies them to the calculation unit 122. The calculation unit 122 estimates the motion vector of the information processing apparatus 100 on the basis of the spatial magnetic gradient and the temporal magnetic change.

[Regarding Geomagnetic Map]

FIG. 2 is a schematic diagram showing an example of a geomagnetic map, in which the geomagnetic strength is expressed in shades. FIG. 2 shows a geomagnetic map in, for example, a particular room indoors. As shown in the figure, the geomagnetism is not uniform even indoors, and is distorted due to the influence of reinforcing bars of building materials, or the like. In the existing method, a geomagnetic map as shown in FIG. 2 is created by measurement in advance, and the geomagnetism detected by a magnetic sensor is compared with the geomagnetic map to detect the own position.

However, in this case, there is a need to create a geomagnetic map in advance and update the geomagnetic map at predetermined periods. Meanwhile, in the method according to the present technology, there is no need to create the geomagnetic map as shown in FIG. 2.

[Regarding Estimation of Motion Vector]

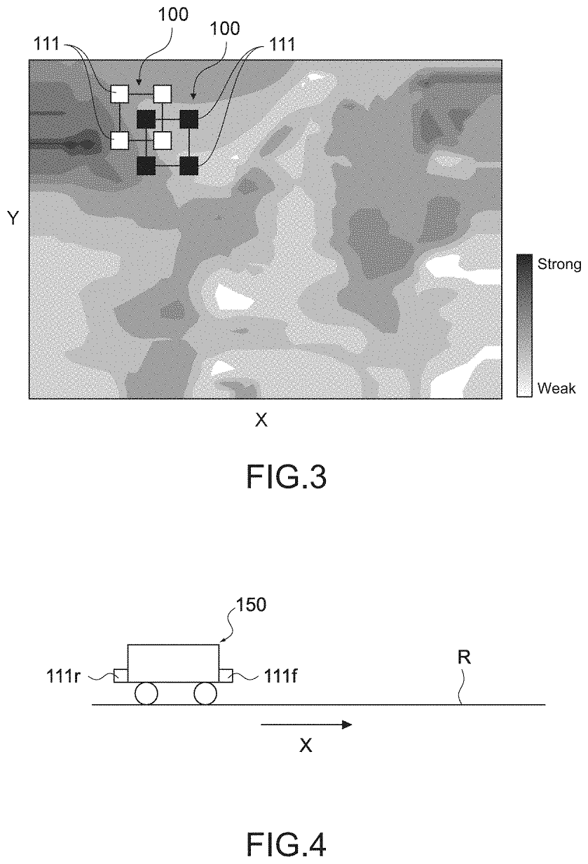

Estimation of a motion vector by the information processing apparatus 100 will be described. FIG. 3 is a schematic diagram showing the principle of estimation of a motion vector by the information processing apparatus 100. As shown in the figure, assumption is made that the information processing apparatus 100 moves in an environment in which there is geomagnetism distortion. The information processing apparatus 100 at a time T1 is indicated by white, and the information processing apparatus 100 at a time T after a time a from the time T1 is indicated by black.

At the time T1, the magnetic sensor 111 detects geomagnetism in the vicinity thereof, and acquires the geomagnetism distribution of the periphery thereof. When the information processing apparatus 100 between the time T1 and the time T2, each magnetic sensor 111 detects geomagnetism in the vicinity thereof, and acquires the geomagnetism distribution on the periphery thereof.

The information processing apparatus 100 compares the geomagnetism distribution at the time T1 and the geomagnetism distribution at the time T2 with each other to calculate the motion vector of the information processing apparatus 100. The information processing apparatus 100 estimates the velocity vector (motion vector) of the information processing apparatus 100 by dividing the calculated motion vector by the time a.

Hereinafter, the method of estimating a motion vector will be described more specifically. First, the method in which the information processing apparatus 100 detects a one-dimensional motion vector will be described. FIG. 4 is a schematic diagram showing the movement of a moving object 150 on which the information processing apparatus 100 is mounted. The moving object 150 is, for example, a bogie, and assumption is made that the bogie moves in an X direction along a rail R as shown in the figure.

The magnetic sensor 111 is disposed on the front side and the rear side of the moving object 150 with respect to the traveling direction (X direction). Hereinafter, the magnetic sensor 111 disposed on the front side of the moving object 150 is referred to as the magnetic sensor 111f, and the magnetic sensor 111 disposed on the rear side is referred to as the magnetic sensor 111r. The magnetic sensor 111f and the magnetic sensor 111r are disposed so as to be spaced part from each other by a predetermined distance, e.g., 5 cm, in the traveling direction (X direction) of the moving object 150.

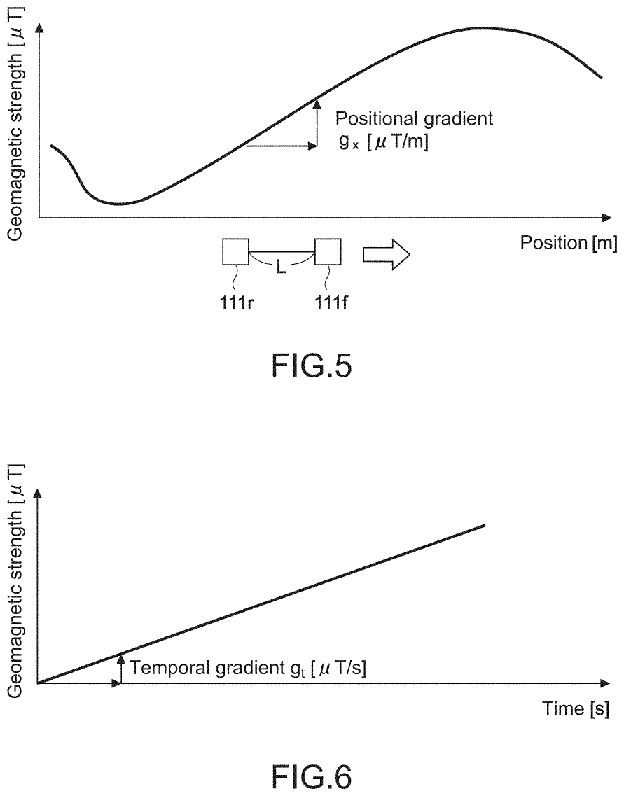

FIG. 5 is a graph showing an example of the position along the X direction and the geomagnetic strength. As shown in the figure, the distance between the magnetic sensor 111f and the magnetic sensor 111r is defined as L. Further, a magnetic strength detected by the magnetic sensor 111f at the time t is defined as B_{f}(t), and a magnetic strength detected by the magnetic sensor 111r at the time t is defined as Bᵣ(t). Here, a positional gradient gₓ(t) [μ/m] at the time t is represented by the following (Formula 1).

$$\begin{matrix}[ Math . 1 ] & \\ {g}_{x} ( t ) = \frac{{B}_{f} ( t ) - {B}_{r} ( t )}{L} & ( Formula 1 )\end{matrix}$$

That is, the geomagnetic strength has a slope gₓ(t) in the vicinity of the moving object 150. Further, FIG. 6 is a graph showing an example of the geomagnetic strength for time, which is detected by the magnetic sensor 111f. As shown in the figure, a temporal gradient gₜ(t) [μT/s] in a predetermined time T is represented by the following (Formula 2).

$$\begin{matrix}[ Math . 2 ] & \\ {g}_{t} ( t ) = \frac{{B}_{1} ( t ) - {B}_{f} ( t - T )}{T} & ( Formula 2 )\end{matrix}$$

That is, the geomagnetic strength detected by the magnetic sensor 111f has a gradient gₜ(t) in one second. The following (Formula 3) can be derived from the (Formula 1) and the (Formula 2). Note that v(t) represents L/T.

[Math. 3]

gₓ(t)v(t)=gₜ(t) (Formula 3)

The following (Formula 4) can be derived by modifying the (Formula 3).

$$\begin{matrix}[ Math . 4 ] & \\ v ( t ) = \frac{{g}_{t} ( t )}{{g}_{x} ( t )} & ( Formula 4 )\end{matrix}$$

Therefore, the velocity v(t) along the X direction is gₜ(t)/gₓ(t), and the moving object 150 has moved gₜ(t)/gₓ(t) [m] in one second. In this way, the one-dimensional velocity (i.e., motion vector) of the moving object 150 can be calculated on the basis of the detection results of the two magnetic sensors of the magnetic sensor 111f and the magnetic sensor 111r.

[Operation of Information Processing Apparatus]

As described above, the information processing apparatus 100 is capable of calculating the one-dimensional motion vector by acquiring the spatial magnetic gradient (the positional gradient gₓ(t)) and the temporal magnetic change (the temporal gradient gₜ(t)) by at least two magnetic sensors 111 positioned along the traveling direction.

Specifically, in the information processing apparatus 100, the acquisition unit 121 acquires the positional gradient gₓ(t) and the temporal gradient gₜ(t) from the plurality of magnetic sensors 111 positioned along the traveling direction of the respective magnetic sensors 111. The acquisition unit 121 supplies the acquired positional gradient gₓ(t) and the acquired temporal gradient gₜ(t) to the calculation unit 122.

The calculation unit 122 calculates the motion vector v(t) from the positional gradient gₓ(t) and the temporal gradient gₜ(t) as described above. Further, the calculation unit 122 is capable of calculating the amount of movement of the moving object 150 by integrating the motion vector.

[Regarding Two-Dimensional Motion Vector and Three-Dimensional Motion Vector]

As described above, in the information processing apparatus 100, a one-dimensional motion vector can be calculated on the basis of the outputs of the two magnetic sensors 111 disposed along the traveling direction of the moving object, but this can be expanded to two-dimensional one and three-dimensional one.

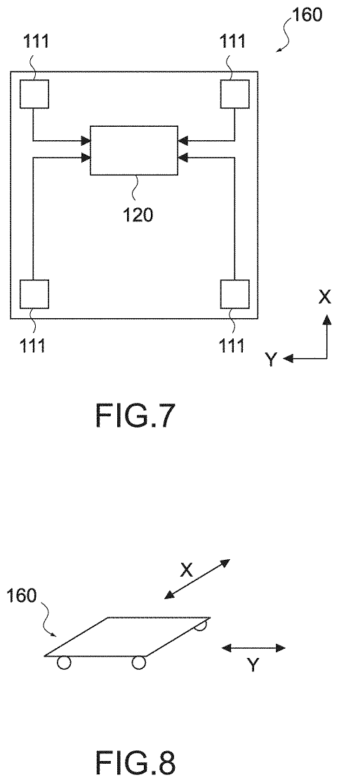

FIG. 7 is a schematic diagram showing a moving object 160 on which the information processing apparatus 100 capable of calculating a two-dimensional motion vector is mounted, and FIG. 8 is a schematic diagram showing how the moving object 160 moves. As shown in the figure, the moving object 160 is, for example, a bogie robot capable of moving on the X-Y plane in a warehouse or the like.

As shown in FIG. 7, four magnetic sensors 111 separated from each other in the moving direction (X direction and Y direction) of the moving object 160 are disposed in the moving object 160. The distances between the magnetic sensors 111 are approximately 5 cm in the X direction and the Y direction.

The information processing unit 120 is capable of calculating a two-dimensional motion vector by calculating the one-dimensional motion vectors in the X direction and the Y direction as described above and combining the vectors. Note that the information processing unit 120 is capable of calculating the two-dimensional motion vector on the basis of outputs of three magnetic sensors 111 separated from each other in the X direction and the Y direction, and is capable of more accurately calculating the two-dimensional motion vector by including four or more magnetic sensors 111.

Further, the information processing unit 120 is capable of calculating the amount of movement of the moving object 160 on the X-Y plane by integrating the two-dimensional motion vector.

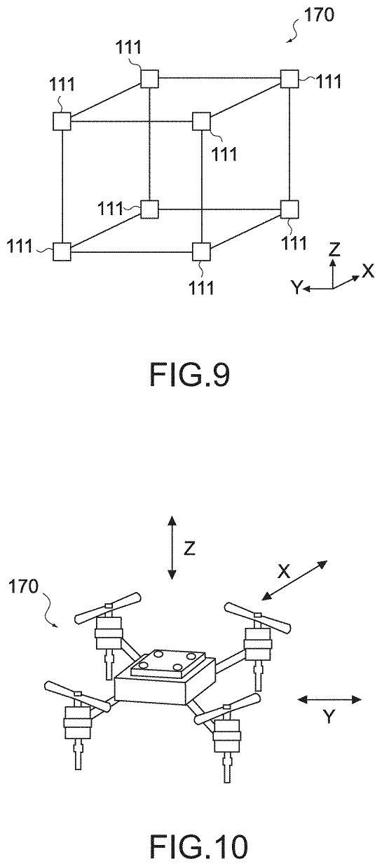

FIG. 9 is a schematic diagram of a moving object 170 on which the information processing apparatus 100 capable of calculating a three-dimensional motion vector is mounted. Note that illustration of the information processing unit 120 is omitted in FIG. 9. FIG. 10 is a schematic diagram showing how the moving object 170 moves. As shown in the figure, the moving object 170 is, for example, a drone capable of moving in X-Y-Z space.

As shown in FIG. 9, eight magnetic sensors 111 separated from each other in the moving direction (X direction, Y direction, and Z direction) of the moving object 170 are disposed in the moving object 170. The distances between the magnetic sensors 111 are approximately 5 cm in the X direction, the Y direction, and the Z direction.

The information processing unit 120 is capable of calculating a three-dimensional motion vector by calculating the one-dimensional motion vectors in the X direction, the Y direction, and the Z direction as described above and combining the vectors. Note that the information processing unit 120 is capable of calculating the three-dimensional motion vector on the basis of outputs of four magnetic sensors 111 separated from each other in the X direction, the Y direction, and the Z direction, and is capable of more accurately calculating the three-dimensional motion vector by including five or more magnetic sensors 111.

Further, the information processing unit 120 is capable of calculating the amount of movement of the moving object 170 in the X-Y-Z space by integrating the three-dimensional motion vector.

[Effects of Information Processing Apparatus]

As described above, the information processing apparatus 100 is capable of calculating a motion vector and the amount of movement on the basis of outputs of the plurality of magnetic sensors 111 disposed separately from each other in the moving direction, and does not require a geomagnetic map as shown in FIG. 2.

For this reason, there is no need to create a geomagnetic map in advance, and it is possible to immediately perform autonomous positioning even in a place used for the first time. Further, a camera is required and power consumption is large in a method using optical observation such as SLAM and LiDAR, while a camera is not required and power required for measuring geomagnetism is small in the information processing apparatus 100, making it possible to reduce the power consumption.

[Another Configuration of Magnetic Detection Unit]

As described above, the information processing apparatus 100 is capable of acquiring a spatial magnetic gradient (the positional gradient gₓ(t)) and a temporal magnetic change (the temporal gradient gₜ(t)) from the outputs of the plurality of magnetic sensors 111 disposed separately from each other in the moving direction. Here, the information processing apparatus 100 may use a magnetic gradient sensor instead of the plurality of magnetic sensors 111.

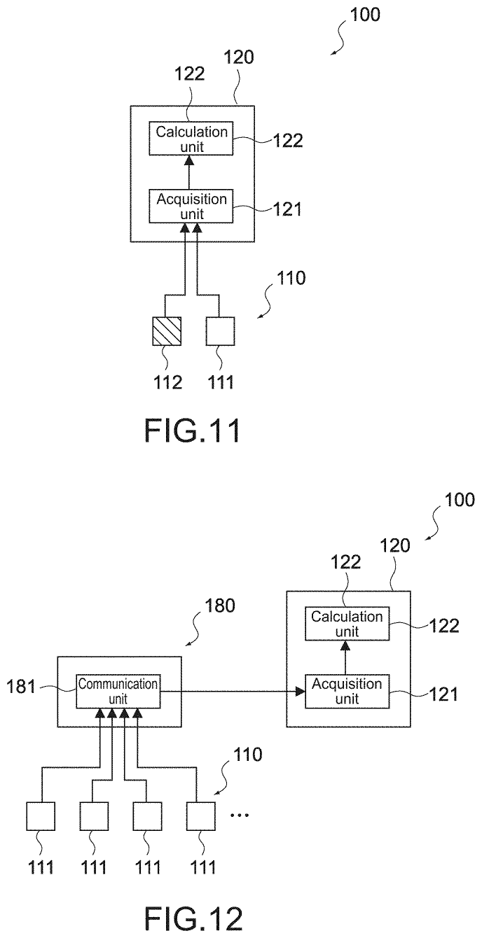

FIG. 11 is a schematic diagram of the information processing apparatus 100 using a magnetic gradient sensor 112. As shown in the figure, the magnetic detection unit 110 includes one magnetic sensor 111 and one magnetic gradient sensor 112. The magnetic gradient sensor 112 is a sensor capable of detecting a spatial magnetic gradient (the positional gradient gₓ(t), see FIG. 5) alone.

The acquisition unit 121 is capable of acquiring a spatial magnetic gradient (the positional gradient gₓ(t)) from the magnetic gradient sensor 112 and acquiring a temporal magnetic change (the temporal gradient gₜ(t)) from the magnetic sensor 111. The use of the magnetic gradient sensor 112 eliminates the necessity of disposing the plurality of magnetic sensors 111 separately from each other and facilitates mounting on a small-sized moving object or HMD (Head Mounted Display).

[Another Configuration of Information Processing Apparatus]

Although the case where the information processing apparatus 100 is mounted on a mobbing object such as a bogie robot has been described above, the information processing apparatus 100 may be another apparatus other than the moving object.

FIG. 12 is a schematic diagram showing the information processing apparatus 100 that is another apparatus other than the moving object. As shown in the figure, the information processing apparatus 100 is connected to a moving object 180. The moving object 180 includes the magnetic detection unit 110 including the plurality of magnetic sensors 111, and a communication unit 181.

The communication unit 181 acquires a spatial magnetic gradient and a temporal magnetic change of the periphery of the moving object 180 from the output of each magnetic sensor 111, and transmits them to the acquisition unit 121.

The acquisition unit 121 acquires a spatial magnetic gradient and a temporal magnetic change of the periphery of the moving object 180 from the communication unit 181, and supplies them to the calculation unit 122. The calculation unit 122 calculates the motion vector of the moving object 180 by the above-mentioned method. Note that a plurality of moving objects 180 may be connected to the information processing apparatus 100.

[Combination with Inertial Measurement Device]

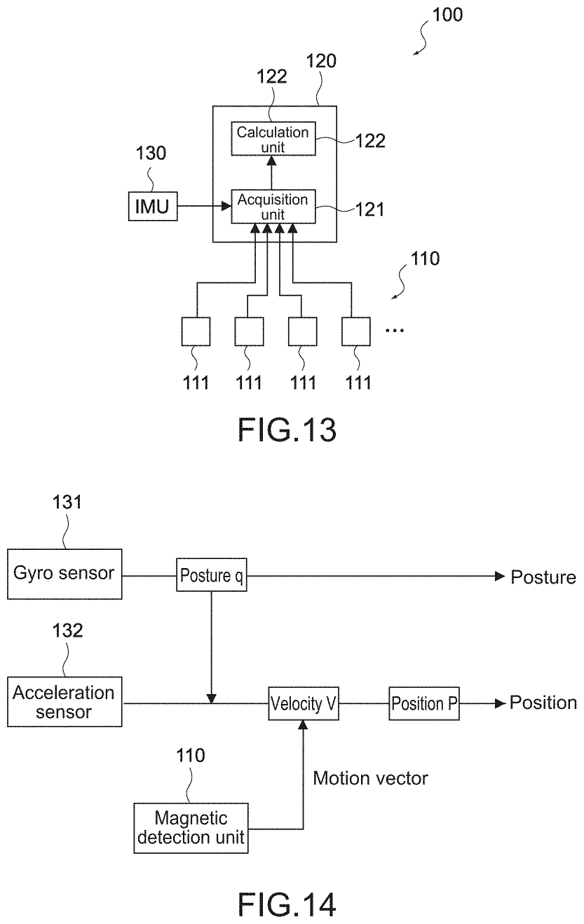

The information processing apparatus 100 may perform autonomous positioning using an inertial measurement device (IMU: inertial measurement unit) in conjunction with the magnetic detection unit 110. FIG. 13 is a schematic diagram of the information processing apparatus 100 including an IMU 130. The IMU 130 incorporates a gyro sensor and an acceleration sensor, and detects the acceleration and posture (angular velocity) of the information processing apparatus 100.

The acquisition unit 121 acquires a spatial magnetic gradient and a temporal magnetic change from the magnetic detection unit 110 and acceleration and posture from the IMU 130, and supplies them to the calculation unit 122.

The calculation unit 122 performs positioning calculation on the basis of the outputs of the magnetic detection unit 110 and the IMU 130. FIG. 14 is a schematic diagram showing the method of positioning calculation based on the outputs of the magnetic detection unit 110 and the IMU 130. As shown in the figure, the calculation unit 122 acquires the angular velocity of the information processing apparatus 100 from a gyro sensor 131 of the IMU 130, and calculates a posture q of the information processing apparatus 100 by integrating the angular velocity.

Further, the calculation unit 122 acquires the acceleration of the information processing apparatus 100 from an acceleration sensor 132 of the IMU 130 and integrates the acceleration, thereby calculating a velocity V of the information processing apparatus 100. At this time, the calculation unit 122 uses the value of the posture q to cancel the influence of the gravitational acceleration.

The calculation unit 122 corrects the velocity V by the motion vector calculated on the basis of the output of the magnetic detection unit 110. The velocity V may have an error due to integration of the acceleration in some cases, and this error can be corrected by the motion vector.

Subsequently, the calculation unit 122 integrates the velocity V, and calculates a position P of the information processing apparatus 100. As described above, by correcting the detection result of the IMU 130 on the basis of the detection result of the magnetic detection unit 110, the information processing apparatus 100 is capable of calculating the position and posture of the information processing apparatus 100 with high accuracy.

Further, although the rotational motion of the information processing apparatus 100 cannot be captured only by the magnetic detection unit 110, the motion of 6 axes (translational 3 axes+rotational 3 axes) can be captured by integrating the detection result of the IMU 130 and the detection result of the magnetic detection unit 110. As a result, it is possible to estimate, in the case where the information processing apparatus 100 is mounted on a drone or the like, the position and posture thereof with higher accuracy.

[Combination with Optical Positioning Device]

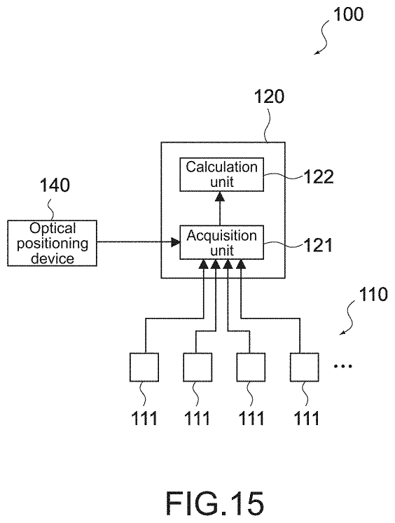

The information processing apparatus 100 is also capable of estimating the position of a moving object by combining the above-mentioned magnetic detection unit 110 with an optical positioning device. FIG. 15 is a schematic diagram showing a configuration of the information processing apparatus 100 including an optical positioning device 140. The optical positioning device 140 is a device capable of estimating the own position by optical observation such as SLAM and LiDAR.

As shown in FIG. 15, the acquisition unit 121 is connected to the optical positioning device 140 as well as the magnetic detection unit 110, and is capable of acquiring the amount of movement estimated by the optical positioning device 140.

Taking a situation where a plurality of bogie robots is operating in a factory or the like as an example, an optical positioning device such as SLAM/LiDAR is generally mounted on the bogie robot. However, in the case where there are a large number of moving objects, the optical positioning device erroneously recognizes a moving object as a fixed object, and the position estimation accuracy is lowered. In this regard, in the information processing apparatus 100, the position estimation accuracy can be prevented from being lowered by the following control.

### Control Example 1

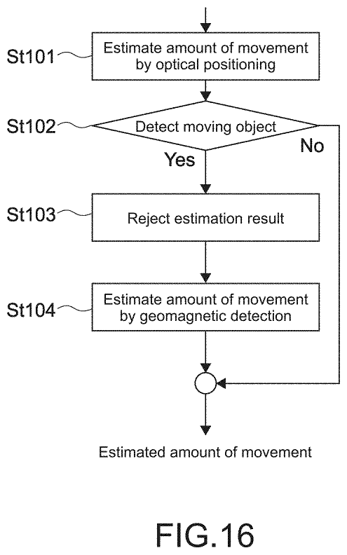

FIG. 16 is a flowchart showing a control example 1 of the information processing apparatus 100 including the optical positioning device 140. As shown in the figure, the optical positioning device 140 estimates the amount of movement of the information processing apparatus 100 (St101), and the calculation unit 122 acquires the amount of movement via the acquisition unit 121. When the optical positioning device 140 detects another moving object (St102: Yes), the calculation unit 122 rejects the estimation result of the optical positioning device 140 (St103).

Subsequently, the calculation unit 122 calculates, on the basis of the spatial magnetic gradient and the temporal magnetic change acquired by the acquisition unit 121 from the magnetic detection unit 110, a motion vector and estimates the motion vector (St104).

Further, in the case where another moving object is not detected (St102: No) by the optical positioning device 140, the calculation unit 122 uses the amount of movement estimated by the optical positioning device 140 as the amount of movement of the information processing apparatus 100. As described above, the information processing apparatus 100 normally employs the amount of movement estimated by the optical positioning device 140, and estimates, when another moving object is detected, the amount of movement on the basis of the output of the magnetic detection unit 110.

When another moving object enters the observation range of the optical positioning device 140, the position estimation accuracy of the optical positioning device 140 is lowered. Meanwhile, since the magnetic field is attenuated by the third power of the distance, it is less affected by a moving object such as a bogie robot. Therefore, by estimating, when another moving object is detected by the optical positioning device 140, the amount of movement on the basis of the output of the magnetic detection unit 110, it is possible to prevent the position estimation accuracy from being lowered by another moving object.

### Control Example 2

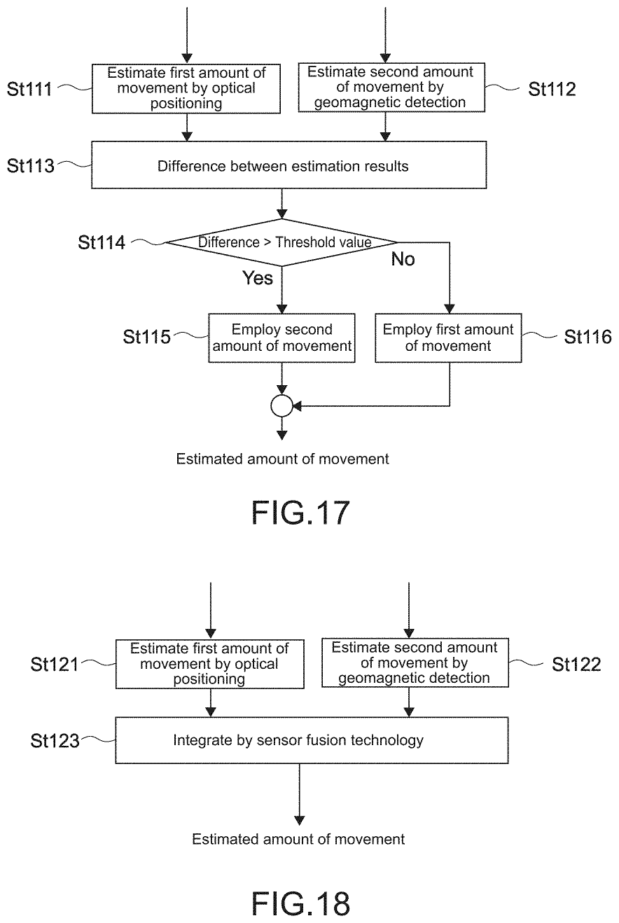

FIG. 17 is a flowchart showing a control example 2 of the information processing apparatus 100 including the optical positioning device 140. As shown in the figure, the optical positioning device 140 estimates the amount of movement of the information processing apparatus 100 (hereinafter, the first amount of movement) (St111), and the calculation unit 122 acquires the first amount of movement via the acquisition unit 121. Further, the calculation unit 122 estimates the amount of movement (hereinafter, second amount of movement) on the basis of the output of the magnetic detection unit 110 (St112).

Subsequently, the calculation unit 122 compares the first amount of movement and the second amount of movement with each other, and calculates the difference between them (St113). In the case where the difference is larger than a predetermined threshold value (St114: Yes), the calculation unit 122 employs the second amount of movement as the amount of movement of the information processing apparatus 100 (St115). Further, in the case where the difference is lower than or equal to the predetermined threshold value (St114: No), the calculation unit 122 employs the first amount of movement as the information processing apparatus 100 (St116).

In this control method, it is possible to determine the reliability of the first amount of movement (amount of movement by the estimation of the optical positioning device 140) by using the second amount of movement (amount of movement based on the output of the magnetic detection unit 110) that is hardly affected by another moving object as a reference, and determine which amount of movement is to be employed in accordance with the reliability.

### Control Example 3

FIG. 18 is a flowchart showing a control example 3 of the information processing apparatus 100 including the optical positioning device 140. As shown in the figure, the optical positioning device 140 estimates the amount of movement of the information processing apparatus 100 (St121), and the calculation unit 122 acquires the amount of movement (hereinafter, the first amount of movement) via the acquisition unit 121. Further, the calculation unit 122 estimates the amount of movement (hereinafter, the second amount of movement) on the basis of the output of the magnetic detection unit 110 (St122).

Subsequently, the calculation unit 122 integrates the first amount of movement and the second amount of movement by a sensor fusion technology (St123). The sensor fusion technology includes a Kalman filter, a particle filter, and the like. In this control method, by integrating the first amount of movement (amount of movement by the estimation of the optical positioning device 140) that is highly accurate but susceptible to another moving object and the second amount of movement that is less susceptible to another moving object, it is possible to achieve both high accuracy and the tolerance to another moving object.

Note that a bogie robot has been described as an example in the above-mentioned control examples, but the present technology is similarly applicable also to a moving object capable of three-dimensionally moving, such as a drone.

### Application Example

Application examples of the information processing apparatus 100 will be described.

### Application Example 1

The information processing apparatus 100 can be used as a picking robot that autonomously travels in a warehouse and picks a package. In the case where a plurality of picking robots operate in a warehouse, they are detected as moving objects to each other in an optical positioning device such as SLAM/LiDAR, and the position estimation accuracy is lowered. Further, warehouses have characteristic magnetostriction due to buildings and shelves and are suitable for application of the present technology.

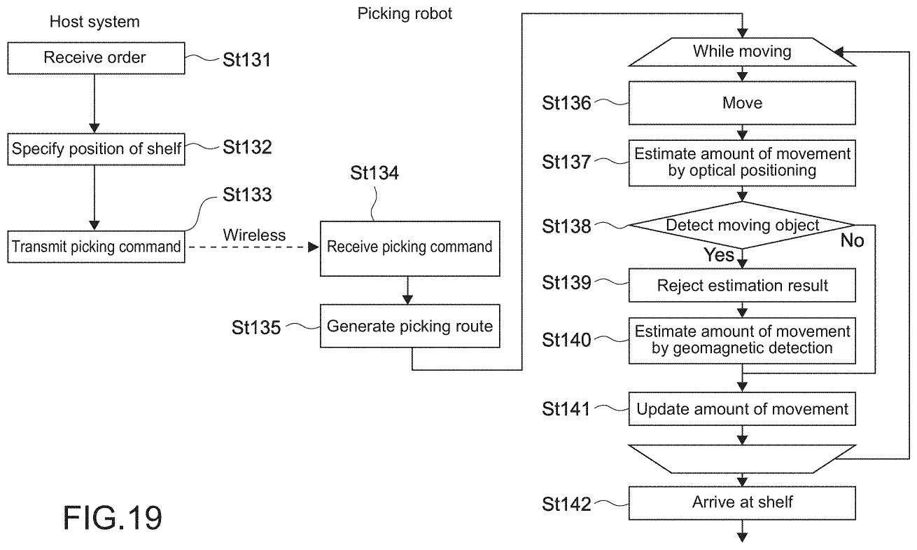

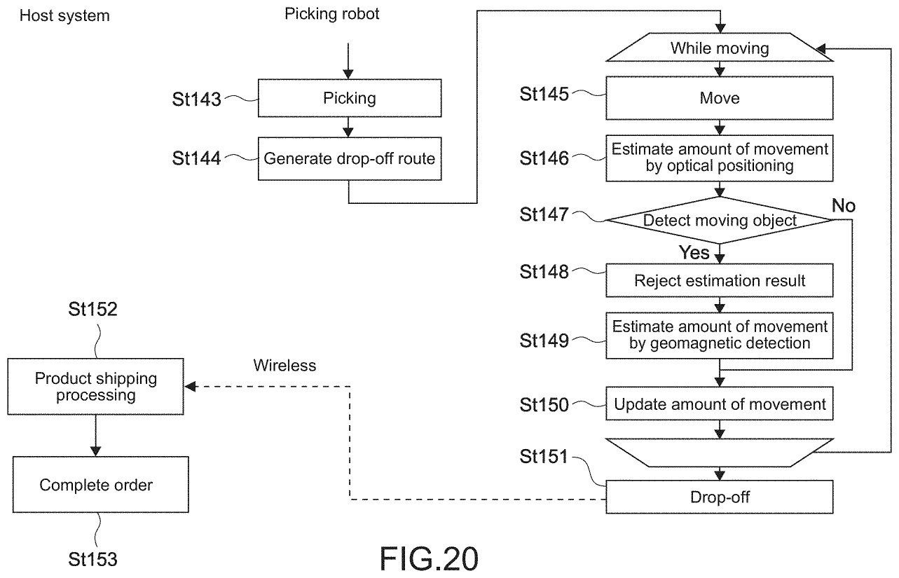

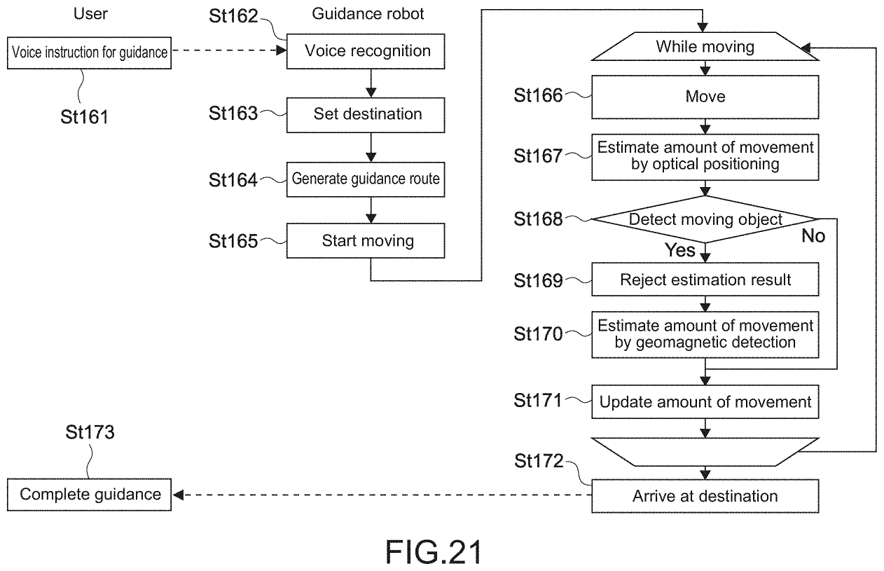

FIG. 19 and FIG. 20 each show a control flowchart of a picking robot on which the information processing apparatus 100 is mounted. The operation of the picking robot is managed by a host system, and includes the information processing apparatus 100 and the optical positioning device 140 (see FIG. 15).

As shown in the figure, when receiving an order (St131), the host system checks it against a database, and specifies the position of the shelf of the ordered product (St132). Further, the host system transmits a picking command to the picking robot in a standby state via wireless communication such as WiFi (St133).

When receiving the picking command (St134), the picking robot generates a picking route (St135) and starts moving. The picking robot estimates the amount of movement of the picking robot by the control method described in the above-mentioned control example 1 while moving (St136).

That is, the picking robot performs the estimation of the amount of movement by the optical positioning device 140 (St137), rejects, when a moving object is detected by the optical positioning device 140 (St138: Yes), the estimation result by the optical positioning device 140 (St139), and estimates the amount of movement on the basis of the output of the magnetic detection unit 110.

Further, in the case where no moving object is detected by the optical positioning device 140 (St138: No), the calculation unit 122 employs the estimation result by the optical positioning device 140. Note that the picking robot may estimate the amount of movement of the picking robot by the control method described above in the control example 2 and the control example 3.

The picking robot updates the amount of movement using the estimated amount of movement (St141). After that, the picking robot repeats the above-mentioned operation until the picking robot arrives at the shelf designated by the host system (St142).

As shown in FIG. 20, when arriving at the shelf, the picking robot picks a product (St143) and generates a drop-off route (St144). After that, the picking robot starts moving in accordance with the drop-off route. The picking robot estimates the amount of movement of the picking robot by the control method described above in the control example 1 while moving (St145).

That is, the picking robot performs the estimation of the amount of movement by the optical positioning device 140 (St146), rejects, when a moving object is detected by the optical positioning device 140 (St147: Yes), the estimation result by the optical positioning device 140 (St148), and estimates the amount of movement on the basis of the output of the magnetic detection unit 110 (St149).

Further, in the case where no moving object is detected by the optical positioning device 140 (St147: No), the calculation unit 122 employs the estimation result by the optical positioning device 140. Note that the picking robot may estimate the amount of movement of the picking robot by the control method described above in the control example 2 and the control example 3.

The picking robot updates the amount of movement using the estimated amount of movement (St150). After that, the picking robot repeats the above-mentioned operation until the picking robot arrives at the drop-off point. When arriving at the drop-off point, the picking robot executes dropping-off (St151), and notifies the host system of the completion of the dropping-off via wireless communication such as WiFi. When receiving this notification, the host system performs product shipping processing (St152), and the order is completed (St153).

### Application Example 2

The information processing apparatus 100 can be used as a guidance robot that autonomously travels in a shopping mall and guides a user. In the case where there are many people in a place such as a shopping mall, an optical positioning device such as SLAM/LiDAR causes erroneous recognition by a person, and the accuracy of position estimation is lowered.

FIG. 18 shows a control flowchart of a guidance robot on which the information processing apparatus 100 is mounted. The guidance robot includes the information processing apparatus 100 and the optical positioning device 140 (see FIG. 15).

As shown in the figure, when a user who desired guidance gives a voice instruction (St161), the guidance robot executes voice recognition processing (St162). The guidance robot sets a destination (St163), generates a guidance route (St164), and starts moving (St165). The guidance robot estimates the amount of movement of the guidance robot by the control method described above in the control example 1 while moving (St166).

That is, the guidance robot performs the estimation of the amount of movement by the optical positioning device 140 (St167), rejects, when a moving object (person) is detected by the optical positioning device 140 (St168: Yes) the estimation result by the optical positioning device 140 (St169), and estimates the amount of movement on the basis of the magnetic detection unit 110 (St170).

Further, in the case where no moving object is detected by the optical positioning device 140 (St168: No), the calculation unit 122 employs the estimation result by the optical positioning device 140. Note that the picking robot may estimate the amount of movement of the picking robot by the control method described above in the control example 2 and the control example 3.

The guidance robot updates the amount of movement using the estimated amount of movement (St171). After that, the guidance robot repeats the above-mentioned operation until the guidance robot arrives at the destination. When arriving at the destination (St172), the guidance robot notifies a user of the completion of the guidance (St173).

Note that although the guidance by the guidance robot has been described in this application example, the information processing apparatus 100 may be mounted on an HMD (Head Mounted Display) and the route may be presented to a user by VR (Virtual Reality), AR (Augmented Reality), or the like.

[Hardware Configuration]

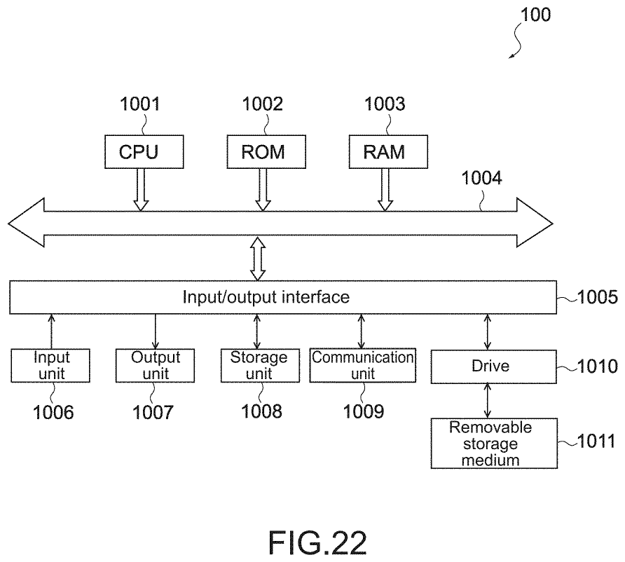

The hardware configuration of the information processing apparatus 100 will be described. FIG. 22 is a schematic diagram showing a hardware configuration of the information processing apparatus 100. As shown in the figure, the information processing apparatus 100 incorporates a CPU (Central Processing Unit) 1001. An input/output interface 1005 is connected to the CPU 1001 via a bus 1004. A ROM (Read Only Memory) 1002 and a RAM (Random Access Memory) 1003 are connected to the bus 1004.

An input unit 1006 that includes an input device such as a keyboard and a mouse for a user to input an operation command, an output unit 1007 that outputs an image of a processing operation screen and a processing result to a display device, a storage unit 1008 that includes a hard disk drive or the like storing a program and various types of data, and a communication unit 1009 that includes a LAN (Local Area Network) adapter or the like and executes communication processing via a network represented by the Internet are connected to the input/output interface 1005. Further, a drive 1010 that reads and writes data to/from a removable storage medium 1011 such as a magnetic disk, an optical disk, a magneto-optical disk, and a semiconductor memory is connected to the input/output interface 1005.

The CPU 1001 executes various types of processing in accordance with a program stored in the ROM 1002 or a program that is read from the removable storage medium 1011 such as a magnetic disk, an optical disk, a magneto-optical disk, and a semiconductor memory, installed in the storage unit 1008, and loaded from the storage unit 1008 into the RAM 1003. Data necessary for the CPU 1001 to execute various types of processing, and the like are appropriately stored in the RAM 1003.

In the information processing apparatus 100 configured as described above, the CPU 1001 loads, for example, the program stored in the storage unit 1008 into the RAM 1003 via the input/output interface 1005 and the bus 1004 and executes the program, whereby the above-mentioned series of processing is executed.

The program executed by the information processing apparatus 100 can be recorded on the removable storage medium 1011 as a package medium or the like and provided. Further, the program can be provided via a wired or wireless transmission medium such as a local area network, the Internet, and digital satellite broadcasting.

In the information processing apparatus 100, the program can be installed in the storage unit 1008 via the input/output interface 1005 by mounting the removable storage medium 1011 on the drive 1010. Further, the program can be received by the communication unit 1009 via a wired or wireless transmission medium and installed in the storage unit 1008. In addition, the program can be installed in the ROM 1002 or the storage unit 1008 in advance.

Note that the program executed by the information processing apparatus 100 may be a program that performs processing in time series in the order described in the present disclosure, or may be a program that performs processing in parallel or at necessary timings such as when a call is made.

Further, all of the hardware configurations of the information processing apparatus 100 need not be mounted on one device, and the information processing apparatus 100 may be configured by a plurality of devices. Further, a part of the hardware configurations of the information processing apparatus 100 may be mounted on a plurality of devices connected via a network.

It should be noted that the present technology may take the following configurations.

(1) An information processing apparatus, including:

an acquisition unit that acquires a spatial magnetic gradient and a temporal magnetic change; and

a calculation unit that estimates a motion vector on a basis of the magnetic gradient and the magnetic change.

(2) The information processing apparatus according to (1) above, in which

the acquisition unit acquires the magnetic gradient and the magnetic change from a magnetic detection unit mounted on a moving object, and

the calculation unit estimates a motion vector of the moving object.

(3) The information processing apparatus according to (2) above, in which

the magnetic detection unit includes a plurality of magnetic sensors that detects geomagnetism, and

the acquisition unit acquires the magnetic gradient from a difference between magnetic strengths output from the plurality of magnetic sensors.

(4) The information processing apparatus according to (2) above, in which

the magnetic detection unit includes a magnetic gradient sensor that detects the magnetic gradient and a magnetic sensor that detects the magnetic change.

(5) The information processing apparatus according to any one of (2) to (4) above, in which

the acquisition unit and the calculation unit are mounted on the moving object.

(6) The information processing apparatus according to any one of (2) to (4) above, in which

the acquisition unit receives the magnetic gradient and the magnetic change from the moving object.

(7) The information processing apparatus according to any one of (2) to (6) above, in which

the calculation unit further estimates, on a basis of the motion vector, an amount of movement of the moving object.

(8) The information processing apparatus according to any one of (3) to (7) above, in which

the magnetic detection unit includes at least two magnetic sensors, and

the calculation unit estimates a one-dimensional motion vector.

(9) The information processing apparatus according to any one of (3) to (7) above, in which

the magnetic detection unit includes at least three magnetic sensors, and

the calculation unit estimates a two-dimensional motion vector.

(10) The information processing apparatus according to any one of (3) to (7) above, in which

the magnetic detection unit includes at least four magnetic sensors, and

the calculation unit estimates a three-dimensional motion vector.

(11) The information processing apparatus according to any one of (2) to (9) above, in which

the acquisition unit further acquires an output of an inertial measurement device, and

the calculation unit corrects, by the motion vector, a velocity calculated on a basis of the output of the inertial measurement device.

(12) The information processing apparatus according to any one of (2) to (9) above, in which

the acquisition unit further acquires an output of an optical positioning device, and

the calculation unit estimates, where another moving object is detected by the optical positioning device, an amount of movement of the moving object on which the magnetic detection unit is mounted, on a basis of the motion vector calculated on a basis of the magnetic gradient and the magnetic change.

(13) The information processing apparatus according to any one of (2) to (9) above, in which

the acquisition unit further acquires an output of an optical positioning device, and

the calculation unit compares a first amount of movement and a second amount of movement with each other, the first amount of movement being estimated on a basis of an output of the optical positioning device, the second amount of movement being estimated on a basis of the motion vector calculated on a basis of the magnetic gradient and the magnetic change, and estimates, where a difference between the first amount of movement and the second amount of movement is larger than a threshold value, the second amount of movement as an amount of movement of the moving object.

(14) The information processing apparatus according to any one of (2) to (9) above, in which

the acquisition unit further acquires an output of an optical positioning device, and

the calculation unit integrates a first amount of movement and a second amount of movement by a sensor fusion technology, the first amount of movement being estimated on a basis of an output of the optical positioning device, the second amount of movement being estimated on a basis of the motion vector calculated on a basis of the magnetic gradient and the magnetic change, and estimates an amount of movement of the moving object.

(15) A computer-readable storage medium stored with a program which, when executed by a processor of an information processing apparatus, causes the information processing apparatus to function as:

an acquisition unit that acquires a spatial magnetic gradient and a temporal magnetic change; and

a calculation unit that estimates a motion vector on a basis of the magnetic gradient and the magnetic change.

(16) An information processing method, including:

acquiring, by an acquisition unit, a spatial magnetic gradient and a temporal magnetic change; and

estimating, by a calculation unit, a motion vector on a basis of the magnetic gradient and the magnetic change.

### REFERENCE SIGNS LIST

100 information processing apparatus
110 magnetic detection unit
111 magnetic sensor
112 magnetic gradient sensor
120 information processing unit
121 acquisition unit
122 calculation unit
130 IMU
140 optical positioning device

1. An information processing apparatus, comprising:
an acquisition unit that acquires a spatial magnetic gradient and a temporal magnetic change; and
a calculation unit that estimates a motion vector on a basis of the magnetic gradient and the magnetic change.

2. The information processing apparatus according to claim 1, wherein
the acquisition unit acquires the magnetic gradient and the magnetic change from a magnetic detection unit mounted on a moving object, and
the calculation unit estimates a motion vector of the moving object.

3. The information processing apparatus according to claim 2, wherein
the magnetic detection unit includes a plurality of magnetic sensors that detects geomagnetism, and
the acquisition unit acquires the magnetic gradient from a difference between magnetic strengths output from the plurality of magnetic sensors.

4. The information processing apparatus according to claim 2, wherein
the magnetic detection unit includes a magnetic gradient sensor that detects the magnetic gradient and a magnetic sensor that detects the magnetic change.

5. The information processing apparatus according to claim 2, wherein
the acquisition unit and the calculation unit are mounted on the moving object.

6. The information processing apparatus according to claim 2, wherein
the acquisition unit receives the magnetic gradient and the magnetic change from the moving object.

7. The information processing apparatus according to claim 2, wherein
the calculation unit further estimates, on a basis of the motion vector, an amount of movement of the moving object.

8. The information processing apparatus according to claim 3, wherein
the magnetic detection unit includes at least two magnetic sensors, and
the calculation unit estimates a one-dimensional motion vector.

9. The information processing apparatus according to claim 3, wherein
the magnetic detection unit includes at least three magnetic sensors, and
the calculation unit estimates a two-dimensional motion vector.

10. The information processing apparatus according to claim 3, wherein
the magnetic detection unit includes at least four magnetic sensors, and
the calculation unit estimates a three-dimensional motion vector.

11. The information processing apparatus according to claim 2, wherein
the acquisition unit further acquires an output of an inertial measurement device, and
the calculation unit corrects, by the motion vector, a velocity calculated on a basis of the output of the inertial measurement device.

12. The information processing apparatus according to claim 2, wherein
the acquisition unit further acquires an output of an optical positioning device, and
the calculation unit estimates, where another moving object is detected by the optical positioning device, an amount of movement of the moving object on which the magnetic detection unit is mounted, on a basis of the motion vector calculated on a basis of the magnetic gradient and the magnetic change.

13. The information processing apparatus according to claim 2, wherein
the acquisition unit further acquires an output of an optical positioning device, and
the calculation unit compares a first amount of movement and a second amount of movement with each other, the first amount of movement being estimated on a basis of an output of the optical positioning device, the second amount of movement being estimated on a basis of the motion vector calculated on a basis of the magnetic gradient and the magnetic change, and estimates, where a difference between the first amount of movement and the second amount of movement is larger than a threshold value, the second amount of movement as an amount of movement of the moving object.

14. The information processing apparatus according to claim 2, wherein
the acquisition unit further acquires an output of an optical positioning device, and
the calculation unit integrates a first amount of movement and a second amount of movement by a sensor fusion technology, the first amount of movement being estimated on a basis of an output of the optical positioning device, the second amount of movement being estimated on a basis of the motion vector calculated on a basis of the magnetic gradient and the magnetic change, and estimates an amount of movement of the moving object.

15. A computer-readable storage medium stored with a program which, when executed by a processor of an information processing apparatus, causes the information processing apparatus to function as:
an acquisition unit that acquires a spatial magnetic gradient and a temporal magnetic change; and
a calculation unit that estimates a motion vector on a basis of the magnetic gradient and the magnetic change.

16. An information processing method, comprising:
acquiring, by an acquisition unit, a spatial magnetic gradient and a temporal magnetic change; and
estimating, by a calculation unit, a motion vector on a basis of the magnetic gradient and the magnetic change.
